(19) United States
(12) Patent Application Publication
(10) Pub. No.: US 2015/0360503 A1
(43) Pub. Date: Dec. 17, 2015

(54) Marker with an Integrated Eraser

(71) Applicant: Daniel Velkovski, Garfield, NJ (US)

(72) Inventor: Daniel Velkovski, Garfield, NJ (US)

(73) Assignees: Michael A Velkovski, Spring Glen, NY (US); Stefan Velkovski, Garfield, NJ (US)

(21) Appl. No.: 14/739,633

(22) Filed: Jun. 15, 2015

Related U.S. Application Data
(60) Provisional application No. 62/011,763, filed on Jun. 13, 2014.

(51) Int. Cl. B43K 29/02; B43K 8/02

(52) U.S. Cl. CPC B43K 29/02; B43K 8/02

(57) ABSTRACT

A dry eraser marker with an integrated dry eraser is an apparatus designed to make the task of writing on a whiteboard more efficient. The attachment mechanism includes a first engagement element and second engagement element. The eraser-receiving cavity laterally traverses into the marker body. The first engagement element is integrated into the marker body, next to the eraser-receiving cavity. The second engagement element is integrated into the dry eraser. The dry eraser is removably attached into the eraser-receiving cavity through the attachment mechanism. More specifically, the second engagement element is positioned adjacent and is engaged to the first engagement element in order to secure the dry eraser to the marker body. The preferred first engagement element is a spring clip and the preferred second engagement element is a clip-receiving hole. The spring clip and clip-receiving hole allow for easy and fast removal of the dry eraser.

The current application claims a priority to the U.S. Provisional Patent application Ser. No. 62/011,763 filed on Jun. 13, 2014. The current application is filed on Jun. 15, 2015 while Jun. 13, 2015 was on a weekend.

### FIELD OF THE INVENTION

The present invention relates generally to an alternative design for dry erase marker. More specifically, the present invention is a dry erase marker with an eraser integrated into its body.

### BACKGROUND OF THE INVENTION

A whiteboard is a glossy white surface that is used to repeatedly write on with a nonpermanent marker. Whiteboards are analogous to chalkboards as they allow for quick writing and erasing on a relatively large scale. Typical whiteboards comprise a laminated chipboard or a steel board that is covered in a polyester or acrylic coating. There are more expensive options as well which use enameled whiteboards but as a result are less popular. Starting around mid-1990s, whiteboards became more popular because they allowed for the use of more vibrant colors and resultantly creating higher contrast content. Additionally, whiteboards are easier to clean and leave little to no mess after use when compared to traditional chalkboards. Whiteboards became extremely popular in learning and working environments such as offices, meeting rooms, school classrooms, and college classrooms. To write on the whiteboard, a nonpermanent dry eraser marker must be used. The whiteboard marker uses an ink which adheres to the top layer of the whiteboard without binding or being absorbed, and thus can be easily removed. Resultantly, any cloth may be utilized to clean the ink of the whiteboard although the majority of whiteboards come with a separate eraser; the eraser is most often times made out of a foam handle with a felt or some type of cloth attached to its underside. The two material compositions yield a light eraser which does not tire the user even after performing frequent erasing motions.

The present invention integrates the eraser into the marker to yield a single sleek and sophisticated whiteboard accessory. Through the integration of a detachable eraser into the marker, the present invention presents a more efficient and elegant alternative to the traditional approaches. There have been inventions which have attempted to incorporate the eraser into the marker, either connecting a piece of cloth to the cap or utilizing a large attachment, but such designs are limited in their erasing surface and most often times negatively alter the handling characteristics of the marker. The present invention is characterized by a sleek, hidden eraser that has a substantial erasing surface when compared to alternative single devices.

### BRIEF DESCRIPTION OF THE DRAWINGS

FIG. 1 is a perspective view of the present invention.

FIG. 2 is an exploded front-perspective view of the present invention.

FIG. 3 is an exploded rear-perspective view of the present invention.

FIG. 4 is an alternative exploded rear-perspective view of the present invention.

### DETAIL DESCRIPTIONS OF THE INVENTION

All illustrations of the drawings are for the purpose of describing selected versions of the present invention and are not intended to limit the scope of the present invention.

The present invention relates generally to whiteboard accessories. More specifically, the present invention is a dry eraser marker with an eraser conveniently integrated into its body. The present invention provides a user with an efficient and user-friendly whiteboard accessory which contains both a dry eraser marker and an eraser. When not in use, the eraser is attached to the dry eraser, flush with the exterior contours. When the user needs to use the eraser, he or she simply disengages the eraser from the dry eraser marker and clears the whiteboard. The present invention may be altered and configured to be integrated into a variety of writing utensils and a variety of designs for said utensils. More specifically, the present invention may be integrated into the body portion of various writing utensils.

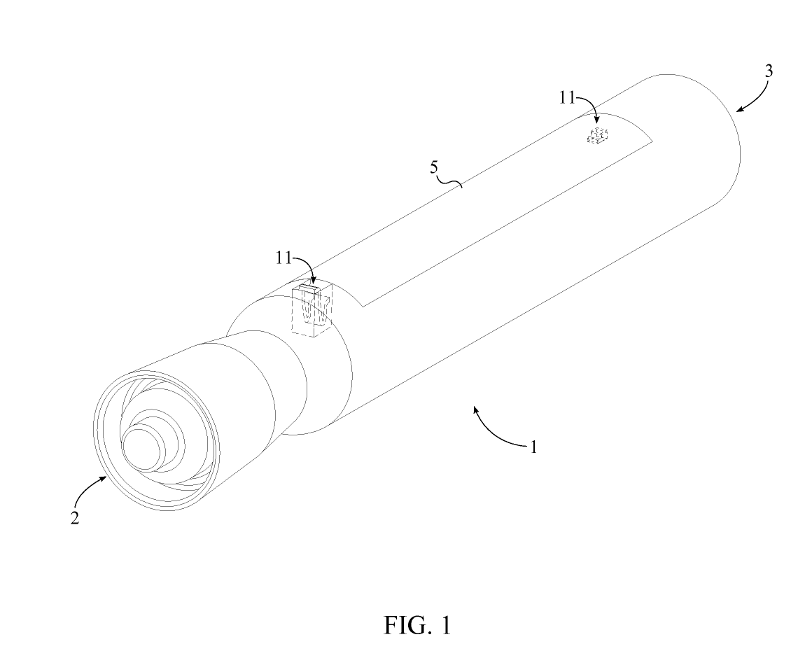

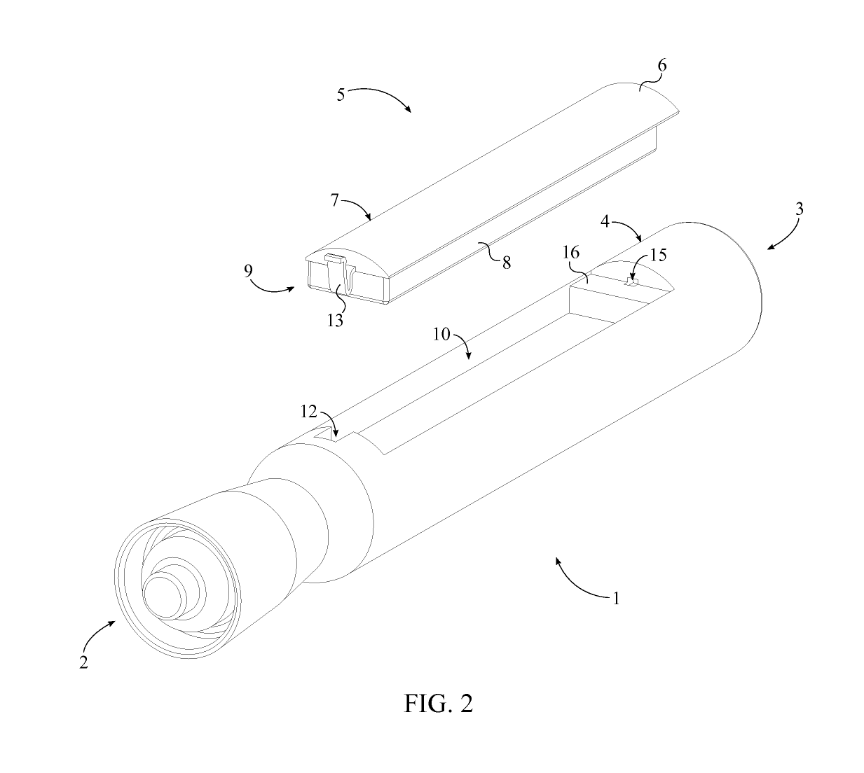

Referring to FIG. 1 and FIG. 2, the present invention comprises a marker body 1, an eraser-receiving cavity 10, a dry eraser 5, and an attachment mechanism 11. The marker body 1 houses the internal components of the marker such as an ink reservoir cartridge and is preferably in the form of a tubular shape with a tapered end. The eraser-receiving cavity 10 laterally traverses into the marker body 1 and facilitates the placement and storage of the dry eraser 5. The dry eraser 5 provides the user with a means to remove ink markings of a whiteboard. The eraser-receiving cavity 10 and the dry eraser 5 are preferably similarly shaped and are sized to interlock with each other in a male-female engagement. When not in use, the dry eraser 5 is removably positioned within the eraser-receiving cavity 10 and is secured to the marker body 1 through the attachment mechanism 11. The attachment mechanism 11 allows for easy detachment of the dry eraser 5 from the marker body 1. The attachment mechanism 11 comprises a first engagement element 12 and a second engagement element 13. The first engagement element 12 is integrated into the marker body 1, adjacent to the eraser-receiving cavity 10. Complimentary to the first engagement element 12, the second engagement element 13 is integrated into the dry eraser 5, adjacent to the first engagement element 12 such that when the dry eraser 5 is positioned within the eraser-receiving cavity 10, the first engagement element 12 engages the second engagement element 13. The first engagement element 12 and the second engagement element 13 fasten the dry eraser 5 to the marker body 1.

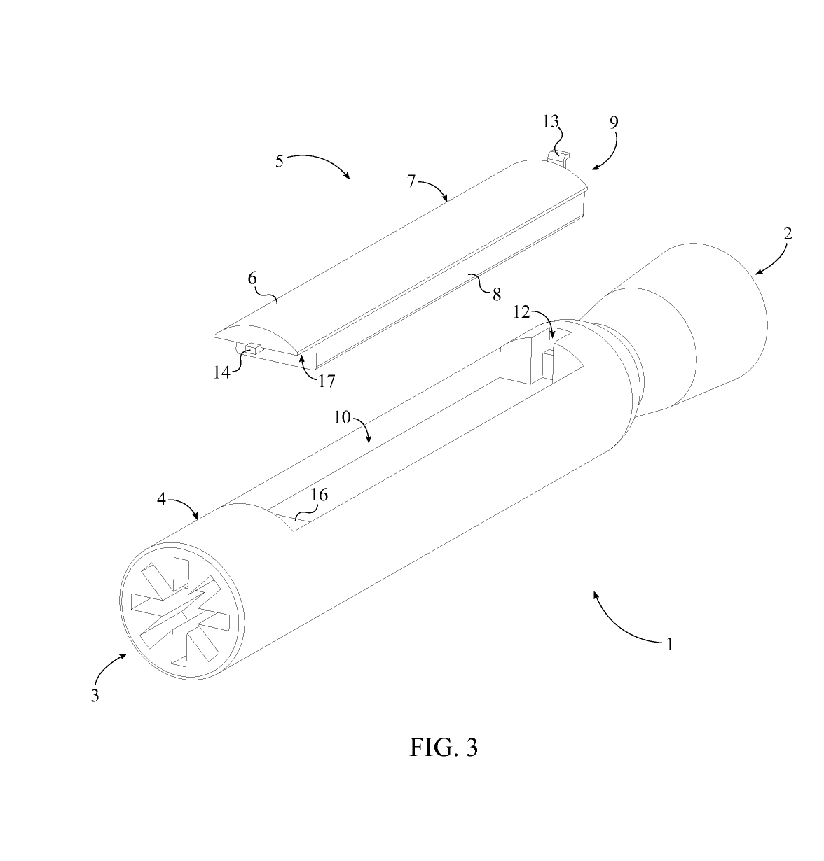

Referring to FIG. 2 and FIG. 3, the marker body 1 comprises a tip end 2 and a base end 3. The tip end 2 and the base end 3 are positioned opposite to each other along the marker body 1 with the eraser-receiving cavity 10 located in between the two components. The eraser-receiving cavity 10 is oriented along the length of the marker body 1 in order to better utilize the shape of the dry eraser 5. The eraser-receiving cavity 10 is positioned offset from the tip end 2 on one side of the marker body 1 and offset from the base end 3 on the other side of the marker body 1. This design ensure the eraser-receiving cavity 10 does not interfere with the functionality of the internal components of the marker.

Referring to FIG. 2, the dry eraser 5 further comprises a cleaning pad 8 and a handle 6. The cleaning pad 8 is the portion of the dry eraser 5 which actually comes in contact with the whiteboard and absorbs/wipes away ink. The cleaning pad 8 is adjacently connected across the handle 6 and composed of materials including, but not limited to, soft cloth, pelt, cotton, felt, foam, microfiber, synthetic fabric, and other typical dry eraser materials. When the dry eraser 5 is positioned within the marker body 1, the cleaning pad 8 is positioned in between the marker body 1 and the handle 6. The cleaning pad 8 is shaped and sized to fit within the eraser-receiving cavity 10; the preferred cleaning pad 8 is a rectangular extrusion composed of the aforementioned materials. The handle 6 is the part of the dry eraser 5 that is designed to be held by the user. The handle 6 is attached to the marker body 1 by the attachment mechanism 11. In order to keep the handling characteristics of the marker body 1 consistent, an outer surface 7 of the handle 6 is shaped to conform to an external surface 4 of the marker body 1 such that a flush alignment is achieved between the marker body 1 and the dry eraser 5 as seen in FIG. 1. Alternatively, the outer surface 7 may be textured, contoured, or made out of gripping material such as rubber to increase the handling characteristics of the dry eraser 5.

Various attachment means may be used for the attachment mechanism 11 of the present invention in order to fasten the dry eraser 5 to the marker body 1. Referring to FIG. 2 and FIG. 3, the preferred first engagement element 12 is a spring clip and the preferred second engagement element 13 is a clip-receiving cavity. The spring clip is positioned adjacent to a first end 9 of the dry eraser 5 and is designed to partially deform under a certain force, allowing the component to act as a locking mechanism. Complimentary to the location of the spring clip, the clip-receiving cavity is also positioned adjacent to the first end 9 of the dry eraser 5. Furthermore, the attachment mechanism 11 may also comprise a tab 14 and a tab-receiving hole 15 to reduce the chances that the dry eraser 5 may accidentally detach from the marker body 1. The tab 14 is connected adjacent to the dry eraser 5, opposite the second engagement element 13. The tab-receiving hole 15 is positioned along the eraser-receiving cavity 10, opposite the first engagement element 12, and traverses into the marker body 1 as seen in FIG. 2. When the dry eraser 5 is positioned within the eraser-receiving cavity 10, the tab 14 is engaged to the tab-receiving hole 15. The first engagement element 12 and the second engagement element 13 attach the first end 9 of the dry eraser 5 to the marker body 1 while the tab 14 and tab-receiving hole 15 attach the opposing end of the dry eraser 5, thus securing the dry eraser 5 to the marker body 1.

In one embodiment of the present invention, the attachment mechanism 11 may include a button on the dry eraser 5 or the marker body 1 which, upon actuation, releases the dry eraser 5 from the eraser-receiving cavity 10. In another embodiment of the present invention, the marker body 1 may contain additional indented grooves on either side of the eraser-receiving cavity 10 which expose the lateral sides of the dry eraser 5; the user may grip these exposed lateral sides to pull the dry eraser 5 from the eraser-receiving cavity 10. In yet another embodiment of the present invention, the eraser-receiving cavity 10 extends all the way to the base end 3 and include internal tracks which the dry eraser 5 may slide on; this slot-type configuration would allow the dry eraser 5 to be slid in and out of the eraser-receiving cavity 10.

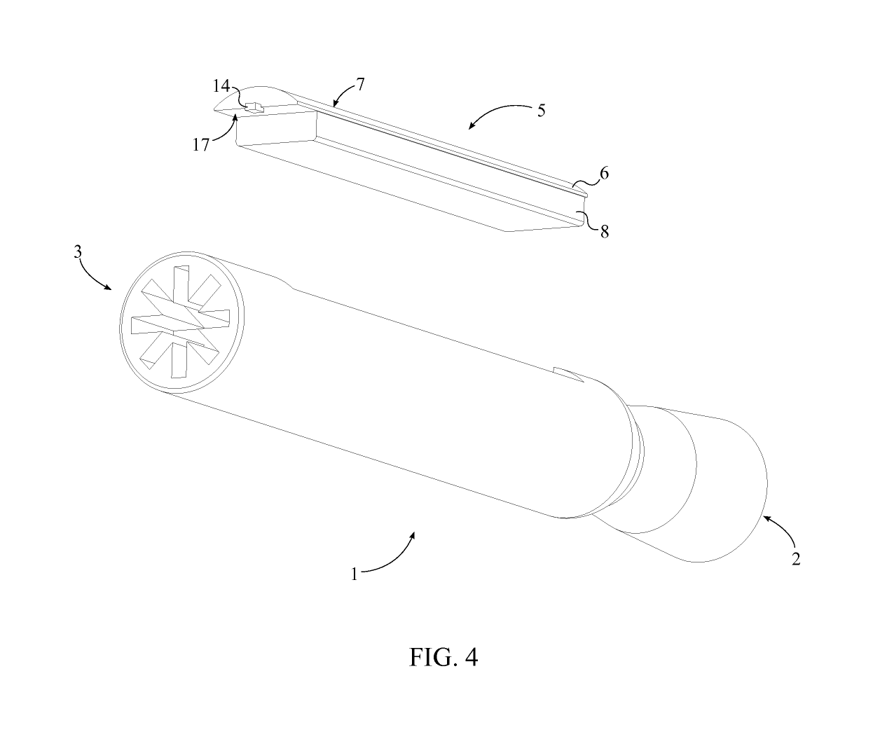

To remove the dry eraser 5, the user simply applies pressure on the spring clip from the tip end 2 towards the base end 3 to release the spring clip from the clip-receiving hole. Next, the user pulls the first end 9 of the dry eraser 5 away from the marker to disengage the tab 14 from the tab-receiving hole 15, thus detaching the dry eraser 5 from the marker body 1. To facilitate this process, a support step 16 and a step-receiving indent 17 are used. The support step 16 is positioned within the eraser-receiving cavity 10, adjacent to the tab-receiving hole 15, and is connected to the marker body 1. The step-receiving indent 17 traverses into the dry eraser 5, opposite the second engagement element 13 as seen in FIG. 4. When the dry eraser 5 is positioned within the eraser-receiving cavity 10, the support step 16 is positioned into the step-receiving indent 17, ensuring a flush alignment as mentioned before. During the removal of the dry eraser 5, the support step 16 acts as the fulcrum point for the dry eraser 5.

Although the invention has been explained in relation to its preferred embodiment, it is to be understood that many other possible modifications and variations can be made without departing from the spirit and scope of the invention as hereinafter claimed.

What is claimed is:

1. A marker with an integrated eraser comprises:
a marker body;
a dry eraser;
an eraser-receiving cavity;
an attachment mechanism;
the attachment mechanism comprises a first engagement element and a second engagement element;
the eraser-receiving cavity laterally traversing into the marker body;
the first engagement element being integrated into the marker body, adjacent to the eraser-receiving cavity;
the second engagement element being integrated into the dry eraser;
the dry eraser being removably positioned within the eraser-receiving cavity;
the second engagement element being positioned adjacent to the first engagement element; and
the first engagement element being engaged to the second engagement element.

2. The marker with an integrated eraser as claimed in claim 1 comprises:
the first engagement element being a spring clip;
the second engagement element being a clip-receiving cavity;
the spring clip being positioned adjacent to a first end of the dry eraser; and
the clip-receiving cavity being positioned adjacent to the first end.

3. The marker with an integrated eraser as claimed in claim 1 comprises:
the attachment mechanism further comprises a tab and a tab-receiving hole;
the tab being connected adjacent to the dry eraser, opposite the second engagement element;
the tab-receiving hole traversing into the marker body;
the tab-receiving hole being positioned along the eraser-receiving cavity, opposite to the first engagement element; and
the tab being engaged to the tab-receiving hole.

4. The marker with an integrated eraser as claimed in claim 3 comprises:
a support step;
a step-receiving indent;
the support step being positioned within the eraser-receiving cavity, adjacent to the tab-receiving hole;
the support step being connected to the marker body;
the step-receiving indent traversing into the dry eraser, opposite to the second engagement element; and
the support step being positioned into the step-receiving indent.

5. The marker with an integrated eraser as claimed in claim 1 comprises:
the dry eraser comprises a handle and a cleaning pad;
the cleaning pad being positioned in between the marker body and the handle;
the cleaning pad being adjacently connected across the handle; and
the handle being attached to the marker body by the attachment mechanism.

6. The marker with an integrated eraser as claimed in claim 1 comprises:
the marker body comprises a tip end and a base end;
the eraser-receiving cavity being oriented along the marker body;
the tip end and the base end being positioned opposite to each other along the marker body;
the eraser-receiving cavity being positioned offset from the tip end; and
the eraser-receiving cavity being positioned offset from the base end.

7. The marker with an integrated eraser as claimed in claim 1 comprises:
the dry eraser further comprises a handle; and
an outer surface of the handle being shaped to conform to an external surface of the marker body.

8. A marker with an integrated eraser comprises:
a marker body;
a dry eraser;
an eraser-receiving cavity;
an attachment mechanism;
the attachment mechanism comprises a first engagement element and a second engagement element;
the eraser-receiving cavity laterally traversing into the marker body;
the first engagement element being integrated into the marker body, adjacent to the eraser-receiving cavity;
the first engagement element being a spring clip;
the second engagement element being integrated into the dry eraser;
the second engagement element being a clip-receiving cavity;
the clip-receiving cavity being positioned adjacent to the first end;
the dry eraser being removably positioned within the eraser-receiving cavity;
the second engagement element being positioned adjacent to the first engagement element;
the spring clip being positioned adjacent to a first end of the dry eraser; and
the first engagement element being engaged to the second engagement element.

9. The marker with an integrated eraser as claimed in claim 8 comprises:
the attachment mechanism further comprises a tab and a tab-receiving hole;
the tab being connected adjacent to the dry eraser, opposite the second engagement element;
the tab-receiving hole traversing into the marker body;
the tab-receiving hole being positioned along the eraser-receiving cavity, opposite to the first engagement element; and
the tab being engaged to the tab-receiving hole.

10. The marker with an integrated eraser as claimed in claim 9 comprises:
a support step;
a step-receiving indent;
the support step being positioned within the eraser-receiving cavity, adjacent to the tab-receiving hole;
the support step being connected to the marker body;
the step-receiving indent traversing into the dry eraser, opposite to the second engagement element; and
the support step being positioned into the step-receiving indent.

11. The marker with an integrated eraser as claimed in claim 8 comprises:
the dry eraser comprises a handle and a cleaning pad;
the cleaning pad being positioned in between the marker body and the handle;
the cleaning pad being adjacently connected across the handle; and
the handle being attached to the marker body by the attachment mechanism.

12. The marker with an integrated eraser as claimed in claim 8 comprises:
the marker body comprises a tip end and a base end;
the eraser-receiving cavity being oriented along the marker body;
the tip end and the base end being positioned opposite to each other along the marker body;
the eraser-receiving cavity being positioned offset from the tip end; and
the eraser-receiving cavity being positioned offset from the base end.

13. The marker with an integrated eraser as claimed in claim 8 comprises:
the dry eraser further comprises a handle; and
an outer surface of the handle being shaped to conform to an external surface of the marker body.

14. A marker with an integrated eraser comprises:
a marker body;
a dry eraser;
an eraser-receiving cavity;
an attachment mechanism;
the attachment mechanism comprises a first engagement element and a second engagement element;
the eraser-receiving cavity laterally traversing into the marker body;
the first engagement element being integrated into the marker body, adjacent to the eraser-receiving cavity;
the first engagement element being a spring clip;
the second engagement element being integrated into the dry eraser;
the second engagement element being a clip-receiving cavity;
the clip-receiving cavity being positioned adjacent to the first end;
the dry eraser being removably positioned within the eraser-receiving cavity;
the second engagement element being positioned adjacent to the first engagement element;
the spring clip being positioned adjacent to a first end of the dry eraser;
the first engagement element being engaged to the second engagement element;
the dry eraser further comprises a handle; and
an outer surface of the handle being shaped to conform to an external surface of the marker body.

15. The marker with an integrated eraser as claimed in claim 14 comprises:
the attachment mechanism further comprises a tab and a tab-receiving hole;
the tab being connected adjacent to the dry eraser, opposite the second engagement element;
the tab-receiving hole traversing into the marker body;
the tab-receiving hole being positioned along the eraser-receiving cavity, opposite to the first engagement element; and
the tab being engaged to the tab-receiving hole.

16. The marker with an integrated eraser as claimed in claim 15 comprises:
a support step;
a step-receiving indent;
the support step being positioned within the eraser-receiving cavity, adjacent to the tab-receiving hole;
the support step being connected to the marker body;
the step-receiving indent traversing into the dry eraser, opposite to the second engagement element; and
the support step being positioned into the step-receiving indent.

17. The marker with an integrated eraser as claimed in claim 14 comprises:
the dry eraser comprises a handle and a cleaning pad;
the cleaning pad being positioned in between the marker body and the handle;
the cleaning pad being adjacently connected across the handle; and
the handle being attached to the marker body by the attachment mechanism.

18. The marker with an integrated eraser as claimed in claim 14 comprises:
the marker body comprises a tip end and a base end;
the eraser-receiving cavity being oriented along the marker body;
the tip end and the base end being positioned opposite to each other along the marker body;
the eraser-receiving cavity being positioned offset from the tip end; and
the eraser-receiving cavity being positioned offset from the base end.
